(19) United States
(12) Patent Application Publication
(10) Pub. No.: US 2005/0270501 A1
(43) Pub. Date: Dec. 8, 2005

(54) Graphic display device

(76) Inventor: Kazushi Yoshida, Shizuoka-shi (JP)

Correspondence Address: MCCORMICK, PAULDING & HUBER LLP, CITY PLACE II, 185 ASYLUM STREET, HARTFORD, CT, 06103, US

(21) Appl. No.: 11/144,403

(22) Filed: Jun. 3, 2005

(30) Foreign Application Priority Data
Jun. 7, 2004 (JP) 2004-168003
Jul. 7, 2004 (JP) 2004-200324

(51) Int. Cl. G03B 21/28

(52) U.S. Cl. 353/99

(57) ABSTRACT

A graphic display device includes a light source; a condenser mirror for condensing light from the light source; a color separation filter; a light tunnel on which light passed through the color separation filter is incident; a relay lens system; a first mirror on which the light passed through the relay lens system is incident; a second mirror on which the light reflected from the first mirror is incident; an optical reflecting device including an array of microscopic mirrors which tilt independently to change an exit angle of light reflected thereby to be switched between an ON state, in which the light travels in a first direction, and an OFF state, in which the light travels in a second direction; an a projection lens on which the light traveling in the first direction is incident to be magnified and projected to a screen.

### CROSS REFERENCE TO RELATED APPLICATIONS

The present invention is related to and claims priority of the following co-pending applications, namely, Japanese Patent Applications No. 2004-168003, which was filed on Jun. 7, 2004, and 2004-200324, which was filed on Jul. 7, 2004.

### BACKGROUND OF THE INVENTION

1. Field of the Invention

The present invention relates to a graphic display device using a two-dimensional matrix of micro-mirrors which are respectively mounted on tiny hinges each enabling the associated micro-mirror to tilt to change the exit angle of reflected light therefrom to create a light or dark pixel on a projection surface through a projection lens.

2. Description of the Related Art

A conventional graphic display device using an array of micro-mirrors arranged in the form of a two-dimensional matrix, wherein the micro-mirrors are respectively mounted on tiny hinges each of which enables the associated micro-mirror to tilt so that the light incident thereon is reflected thereby to travel either toward (ON) or away from (OFF) a projection lens to create a light or dark pixel on a projection surface (screen) through the projection lens, is known in the art. FIG. 4 shows an example of such a conventional graphic display device.

In the graphic display device shown in FIG. 4, after being reflected by a condenser mirror (not shown), the light emitted from a light source (not shown) passes through a color separation filter (not shown) to be separated into primary colors, and subsequently enters a light tunnel (not shown). The light which emerges from the light tunnel passes through a relay lens system 101 to be incident on a total reflection prism 102. The light reflected by the total reflection prism 102 is incident on an optical reflecting device 104 through a cover glass 103. The optical reflecting device 104 contains an array of hinge-mounted microscopic mirrors 104a arranged in the form of a two-dimensional matrix. Each micro-mirror 104a can be driven to tilt independently by the associated tiny hinge to change the exit angle of the reflected light therefrom independently. Each micro-mirror 104a can be switched between an ON state in which the reflected light travels in a direction toward a projection lens 105 and an OFF state in which the reflected light travels in a different direction by changing the exit angle of the reflected light. By switching each micro-mirror ON and OFF in such a manner, a desired image can be projected onto a projection surface through the projection lens 105. This type of graphic display device is disclosed in, e.g., Japanese laid-open patent publication H08-146911.

However, the above described conventional type of graphic display device using the total reflection prism 102 is not compact in size because the relay lens system 101 has to have a large number of lens elements, and also the production cost of the graphic display device is generally high because the total reflection prism 102 is costly. Furthermore, because an optical path of the graphic display device is formed by the relay lens system 101 that includes many lens elements and the total reflection prism 102, the light loss through the large number of optical surfaces of the relay lens system 101 and the total reflection prism 102 is considerable, thus reducing efficiency of the illuminating light for lighting the array of micro-mirrors 104a.

### SUMMARY OF THE INVENTION

The present invention provides a low-cost compact graphic display device having a structure which makes it possible to increase the efficiency of the illuminating light for lighting the array of micro-mirrors.

According to an aspect of the present invention, a graphic display device is provided, including a light source for emitting white light; a condenser mirror for condensing the white light emitted from the light source to form a virtual secondary light source; a color separation filter for periodically producing three primary colors from the white light emitted from the condenser mirror; a light tunnel on which light passed through the color separation filter is incident; a relay lens system through which the light emerging from the light tunnel passes; a first mirror on which the light which passes through the relay lens system is incident; a second mirror on which the light incident on the first mirror and reflected thereby is incident; an optical reflecting device including an array of microscopic mirrors arranged in the form of a two-dimensional matrix on a substrate, the light incident on the second mirror and reflected thereby being incident on the array of microscopic mirrors, wherein each of the microscopic mirrors tilts independently to change an exit angle of light reflected thereby to be switched between an ON state, in which the light reflected by the each microscopic mirror travels in a first direction, and an OFF state, in which the light reflected by the each microscopic mirror travels in a second direction different from the first direction; and a projection lens on which the light traveling in the first direction is incident to be magnified and projected to a screen through the projection lens.

It is desirable for a cut-out portion of the second mirror inside an effective aperture thereof to be formed to prevent light reflected by the array of microscopic mirrors from being partly intercepted by the second mirror before reaching the projection lens.

It is desirable for a cut-out portion of the first mirror inside an effective aperture thereof to be formed to prevent light reflected by the first mirror from being incident directly on the projection lens.

It is desirable for a principal ray of reflected light from the array of microscopic mirrors to be inclined to an optical axis of the projection lens in a direction away from the first mirror and the second mirror.

It is desirable for each microscopic mirror to be rectangular in shape and swing about a rotational axis extending in a widthwise direction of the substrate to be switched between the ON state and the OFF state.

It is desirable for each microscopic mirror to be rectangular in shape and swing about a rotational axis extending in a lengthwise direction of the substrate to be switched between the ON state and the OFF state.

It is desirable for each microscopic mirror to be square in shape and swing about a rotational axis extending in a direction of a diagonal line of a square reflecting surface of the each microscopic mirror.

It is desirable for a reflecting surface of the first mirror to be flat, and a reflecting surface of the second mirror to be spherical.

It is desirable for a reflecting surface of the first mirror to be cylindrical and a reflecting surface of the second mirror to be spherical.

It is desirable for a reflecting surface of the first mirror to be flat, and a reflecting surface of the second mirror to be aspherical.

It is desirable for both a reflecting surface of the first mirror and a reflecting surface of the second mirror to be spherical.

It is desirable for the color separation filter to include a rotary color separation filter having a red filter, a green filter and a blue filter which are arranged at equi-angular intervals about an axis of rotation of the a rotary color separation filter.

In an embodiment, a graphic display device is provided, including a light source; a light tunnel; a condenser optical element for condensing light emitted from the light source upon an incident end of the light tunnel; a rotary color separation filter, provided between the condenser optical element and the incident end of the light tunnel, for producing three primary colors periodically; a relay lens system through which light emerging from an exit end of the light tunnel passes; a first mirror on which the light which passes through the relay lens system is incident; a second mirror on which the light incident on the first mirror to be reflected thereby is incident; an optical reflecting device including an array of microscopic mirrors arranged in the form of a two-dimensional matrix on a substrate, the light incident on the second mirror and reflected thereby being incident on the array of microscopic mirrors, wherein each of the microscopic mirrors tilts independently to change an exit angle of light reflected thereby to be switched between an ON state, in which the light reflected by the each microscopic mirror travels in a first direction, and an OFF state, in which the light reflected by the each microscopic mirror travels in a second direction different from the first direction; and a projection lens on which the light traveling in the first direction is incident to be magnified and projected to a screen through the projection lens.

According to the present invention, the graphic display device can be miniaturized while the efficiency of the illuminating light for lighting the array of micro-mirrors can be increased because the number of optical elements of the relay lens system can be reduced by collecting the light emitted from the relay lens system upon the optical reflecting device via two mirrors. Moreover, the production cost of the graphic display device can be reduced because a total reflection element is not employed in the graphic display device.

### BRIEF DESCRIPTION OF THE DRAWINGS

The present invention will be described below in detail with reference to the accompanying drawings in which:

FIG. 1 is a schematic view of an embodiment of a graphic display device according to the present invention, showing a basic configuration thereof;

FIG. 2 is a plan view of a color separation filter shown in FIG. 1, showing the structure thereof;

FIG. 3A is a schematic view of a comparative example of a portion of a graphic display device, showing the direction of travel of the light reflected from an optical reflecting device through a cover glass;

FIG. 3B is a schematic view of a portion of the graphic display device shown in FIG. 1, showing the direction of travel of the light reflected from the optical reflecting device through the cover glass; and

FIG. 4 is a schematic view of a portion of a conventional graphic display device using a total reflection prism.

### DESCRIPTION OF THE PREFERRED EMBODIMENTS

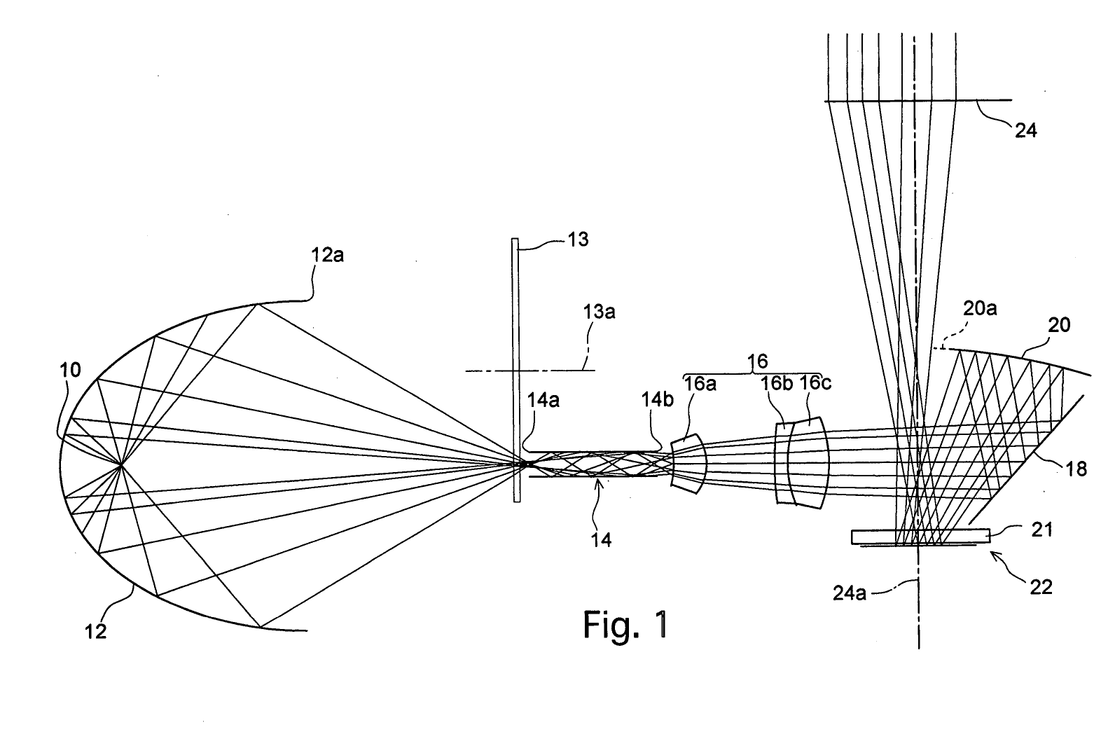

As shown in FIG. 1, an embodiment of a graphic display device is provided with a light source 10, an ellipsoidal condenser mirror (condenser optical element) 12, a rotary color separation filter 13, a light tunnel 14, a relay lens system 16, a first mirror 18, a second mirror 20, a cover glass 21, an optical reflecting device 22 and a projection lens 24.

The light source 10 is a white lamp which can be e.g., a halogen lamp, a xenon lamp, a metal halide lamp or an extra-high pressure mercury lamp.

The condenser mirror 12 surrounds the light source 10. Specifically, the condenser mirror 12 is shaped so that an exit opening 12a thereof is open toward the light tunnel 14. The condenser mirror 12 reflects radiant light from the light source 10 to form a virtual secondary light source which is emitted toward the light tunnel 14 through the exit opening 12a while condensing this light upon an incident end 14a of the light tunnel 14.

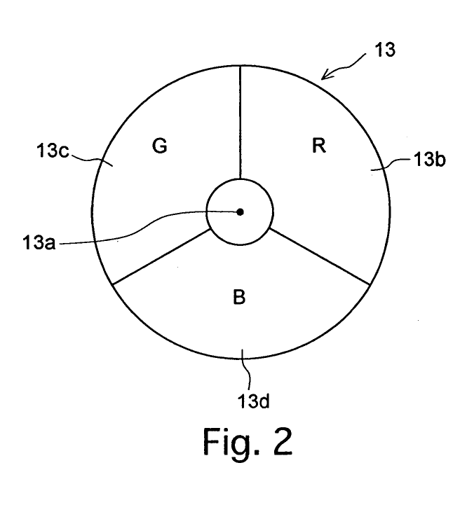

The rotary color separation filter 13 is positioned behind the incident end 14a of the light tunnel 14 to separate the incident light into three primary colors (red light, green light and blue light) periodically. FIG. 2 shows the structure of the rotary color separation filter 13 by way of example. As shown in FIG. 2, the color separation filter 13 is formed in a disc on which a red filter 13b, a green filter 13c and a blue filter 13d are arranged at equi-angular intervals about a central rotational shaft 13a of the color separation filter 13. Applying a light bundle to a fixed spot on the rotary color separation filter 13 from the condenser mirror 12 while rotating the rotary color separation filter 13 at a constant rotational speed causes red light, green light and blue light to emerge from the rotary color separation filter 13 toward the incident end 14a of the light tunnel 14 in sequence at time intervals corresponding to the intervals of the red filter 13b, the green filter 13c and the blue filter 13d.

The light tunnel 14 is formed as a rectangular parallelepiped, and operates so that the incident light on the incident end 14a of the light tunnel 14 is totally reflected a number of times by the inner surface thereof to emerge 14 as uniform light from an exit end 14b of the light tunnel. The light bundle which emerges from the exit end 14b of the light tunnel 14 is magnified through the relay lens system 16, which consists of three lens elements 16a, 16b and 16c, at a predetermined magnification to be projected toward the first mirror 18.

The first mirror 18 has a flat reflecting surface which reflects the incident light from the relay lens system 16 toward the second mirror 20. The second mirror 20 has a concave spherical reflecting surface which reflects the incident light from the first mirror 18 toward the optical reflecting device 22. The light incident on the second mirror 20 is reflected thereby and concentrated on the optical reflecting device 22, specifically, on a two-dimensional array of microscopic mirrors which are respectively mounted on independently drivable tiny hinges (not shown) mounted on a flat substrate 22a of the optical reflecting device 22. A cut-out portion 20a (shown by dotted lines in FIG. 1) of the second mirror 20 inside the effective aperture thereof is removed to prevent the reflected light from the array of microscopic mirrors of the optical reflecting device 22 from being partly intercepted by the second mirror 20 before reaching the projection lens 24. This allows a uniform illumination distribution of the light projected to a screen, or a projection surface (not shown), via the projection lens 24. Among all the light which emerges from the relay lens system 16, the amount of light which is not projected toward the screen through the projection lens 24 can be minimized by the arrangement in which the relay lens system 16 and the two reflecting mirrors (the first and second mirrors 18 and 20) are positioned on opposite sides of an optical axis 24a of the projection lens 24 as shown in FIG. 1. Moreover, the length of the illuminating optical system for focusing an image at the exit end 14b of the light tunnel 14 on the optical reflecting device 22 through the relay lens system 16, the first mirror 18 and the second mirror 20 can be shortened to thereby make it possible to miniaturize the graphic display device.

The optical reflecting device 22 is an optical semiconductor for manipulating light digitally using a two-dimensional matrix of microscopic mirrors mounted on tiny hinges (not shown) mounted on the substrate 22a as noted above. Each micro-mirror is driven to tilt via the associated tiny hinge independently so that the reflected light from the micro mirror travels either in a direction toward the projection lens 24 (ON) or in a different direction (OFF). This variation in exit angle of the reflected light from each micro-mirror of the optical reflecting device 22 is caused by driving the associated tiny hinge (not shown) so that the micro-mirror swings about a rotational axis which is positioned on the reflecting surface of the micro-mirror to extend in either the lengthwise direction or the widthwise direction of the substrate 22a of the optical reflecting device 22 in the case where each micro-mirror is rectangular in plan configuration. If each micro-mirror is square in plan configuration, it is possible for the micro-mirror to be driven to swing about a rotational axis which is positioned on the reflecting surface of the micro-mirror to extend in a diagonal direction of the square reflecting surface of the micro-mirror.

For instance, a digital micromirror device (DMD) produced by Texas Instruments Incorporated can be used as the optical reflecting device 22. If this digital micromirror device is used, each micro-mirror can be angled to be switched between two different angles: an angle of +12 degrees and an angle of −12 degrees relative to a reference horizontal plane. Accordingly, the exit angle of the reflected light from each micro-mirror can be switched between the two different angles. When the light reflected and concentrated by the second mirror 20 is incident on the optical reflecting device 22 through the cover glass 21, positioned immediately in front of the reflecting surface of the optical reflecting device 22, the light reflected by each micro-mirror of the optical reflecting device 22 in an ON state (at the aforementioned angle of +12 degrees) proceeds in a direction toward the projection lens 24, while the light reflected by each micro-mirror of the optical reflecting device 22 in an OFF state (at the aforementioned angle of −12 degrees) does not proceed toward the projection lens 24 but in a different direction. Therefore, the light reflected by the array of micro-mirrors of the optical reflecting device 22 in the ON state is magnified by the projection lens 24 therethrough to be projected onto a screen while the light reflected by the array of micro-mirrors of the optical reflecting device 22 in the OFF state is not projected onto the screen, and accordingly, a desired image can be projected onto the screen by controlling respective operations of the array of micro-mirrors of the optical reflecting device 22 so that each micro-mirror switches ON and OFF in accordance with the bit-streamed image code entering the optical reflecting device 22.

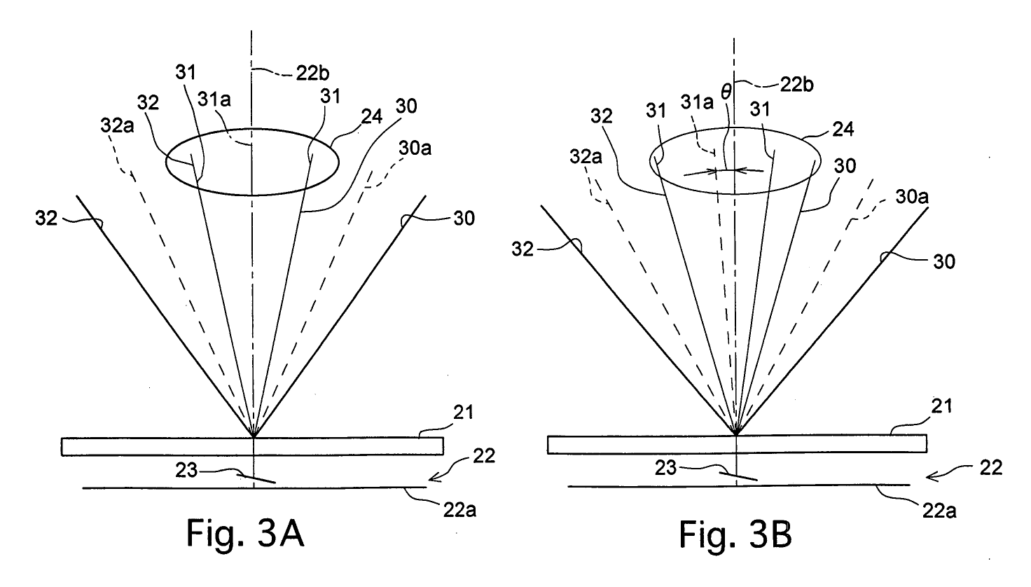

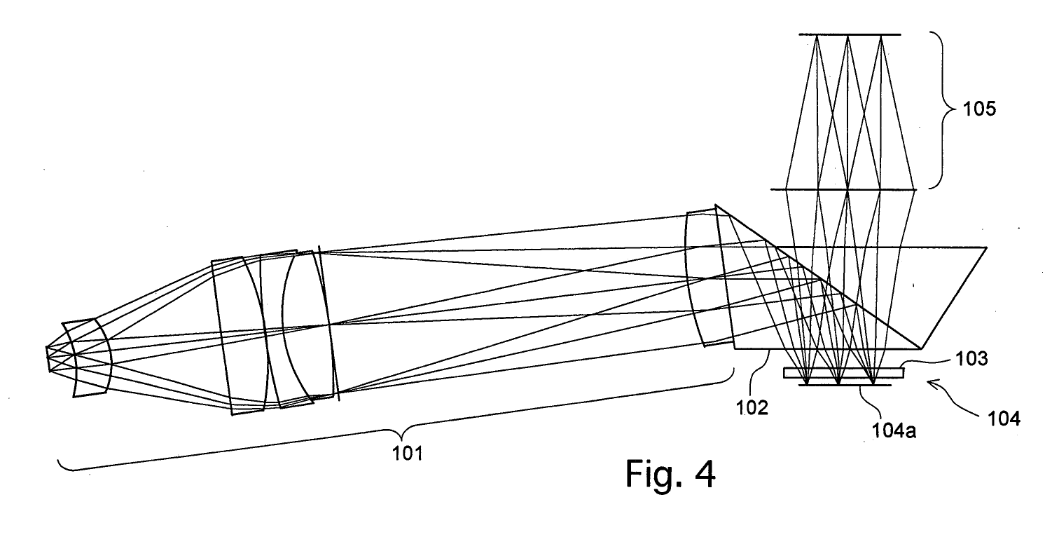

The reflected light from the second mirror 20 is reflected by not only each micro-mirror of the optical reflecting device 22 but also front and rear surfaces of the cover glass 21 and a surface of the substrate of the optical reflecting device 22, and the structure of the array of micro-mirrors of the optical reflecting device 22 may cause a scattering of light. The entry of such a reflected light or the scattered light can lead to reduction in contrast of the light projected onto the screen. FIG. 3A diagrammatically shows a case having such a contrast reduction problem. In FIG. 3A, which shows a portion of a comparative example of a graphic display device which is to be compared with a corresponding portion of the present embodiment of the graphic display device shown in FIG. 1, a principal ray 31a of reflected light 31 from a central micro-mirror 23 positioned at the center of the substrate 22a of the optical reflecting device 22 travels toward the projection lens 24 in the direction of a normal 22b of the substrate 22a of the optical reflecting device 22 to be incident on the projection lens 24 when illuminating light 30 (having a principal ray 30a) is converged onto the central micro-mirror 23 in the ON state through the cover glass 21. At the same time, a part of reflected light 32 (having a principal ray 32a) from the front and rear surfaces of the cover glass 21 and a surface of the substrate 22a are also incident on the projection lens 24.

In contrast, in the present embodiment of the graphic display device shown in FIG. 1, in order to minimize such a reduction in contrast caused by the reflected light 32 from front and rear surfaces of the cover glass 21 and a surface of the substrate 22a, the principal ray 31a of the reflected light 31 from the central micro-mirror 23 in the ON state is inclined with respect to the normal 22b in a direction away from the first mirror 18 and the second mirror 20 by an angle θ as shown in FIG. 3B. This angle of inclination of the principal ray 31a relative to the normal 22b is achieved by applying the illuminating light 30 to the optical reflecting device 22 with the principal ray 30a shown in FIG. 3B being inclined (with respect to the principal ray 30a shown in FIG. 3A) in a direction away from the normal 22b of the optical reflecting device 22. This structure shown in FIG. 3B makes the principal ray 31a of the reflected light 31 from the central micro-mirror 23 travel in a direction away from the normal 22b, and accordingly, makes it possible to minimize the amount of the unwanted reflected light 32 incident on the projection lens 24.

In FIGS. 3A and 3B, a converging point of the illuminating light 30 and a divergence point from which the reflected light 31 diverges and a divergence point from which the reflected light 32 diverges are all positioned at the same point on the front surface (top surface as viewed in FIGS. 3A and 3B) of the cover glass 21 for the purpose of simplifying the drawings.

The reflected light from the optical reflecting device 22 is incident on the projection lens 24, and is magnified through the projection lens 24 at a predetermined magnification to be projected onto a screen. The light bundles reflected by the array of micro-mirrors of the optical reflecting device 22 correspond to the pixels forming an image on the screen in a one-to-one relationship, respectively. By switching each micro-mirror of the optical reflecting device 22 between the ON state and the OFF state, while spinning the rotary color separation filter 13 to separate the incident light thereon into three primary colors periodically, a desired image is projected onto a screen through the projection lens 24.

Modified embodiments of the graphic display devices will be discussed hereinafter.

Although a portion of the second mirror 20 inside the effective aperture thereof is removed in the above illustrated embodiment of the graphic display device, it is desirable that a portion of the first mirror 18 inside the effective aperture thereof be further removed to eliminate the light which is reflected by the first mirror 18 to be incident directly on the projection lens 24, without being reflected by either the second mirror 20 or the optical reflecting device 22.

A reflecting mirror having a concave cylindrical reflecting surface in the shape of an arc in cross section can be used as the first mirror 18. In this case, the reflecting mirror can be positioned so that an axial direction of the cylindrical reflecting surface of the reflecting mirror is orthogonal to the rotational axis of each micro-mirror of the optical reflecting device 22, and so that the reflecting mirror is positioned around the rotational axes of the array of micro-mirrors to be inclined to a plane in which the optical reflecting device 22 lies to reflect light emerging from the relay lens system 16. It is desirable for the reflecting surface of the first mirror 18 be formed in a concave cylindrical reflecting surface in the shape of an arc in cross section to improve the focusing capability of the second mirror 20 on the optical reflecting device 22.

The second mirror 20 that has a concave spherical reflecting surface can be replaced by a mirror having a concave aspherical reflecting surface. If this mirror having a concave aspherical reflecting surface is used as the second mirror 20 to reflect the reflected light from the first mirror 18 by the concave aspherical reflecting surface, the focusing capability of the first mirror 18 on the optical reflecting device 22 via the second mirror 20 is improved.

The first mirror 18 that has a flat reflecting surface can be replaced by a mirror having a spherical reflecting surface. If the reflecting mirror of the first mirror 18 is spherical, the focusing capability of the second mirror 20 on the optical reflecting device 22 is improved.

The light tunnel 14 can be replaced by a fly-eye integrator lens or a rod lens. The light emitted from the condenser mirror 12 can be transmitted to the relay lens system 16 as uniform light in the case where the light tunnel 14 is replaced with a fly-eye integrator lens or a rod lens.

Obvious changes may be made in the specific embodiments of the present invention described herein, such modifications being within the spirit and scope of the invention claimed. It is indicated that all matter contained herein is illustrative and does not limit the scope of the present invention.

1. A graphic display device comprising:
a light source for emitting white light;
a condenser mirror for condensing said white light emitted from said light source to form a virtual secondary light source;
a color separation filter for periodically producing three primary colors from said white light emitted from said condenser mirror;
a light tunnel on which light passed through said color separation filter is incident;
a relay lens system through which said light emerging from said light tunnel passes;
a first mirror on which said light which passes through said relay lens system is incident;
a second mirror on which said light incident on said first mirror and reflected thereby is incident;
an optical reflecting device including an array of microscopic mirrors arranged in the form of a two-dimensional matrix on a substrate, said light incident on said second mirror and reflected thereby being incident on said array of microscopic mirrors, wherein each of said microscopic mirrors tilts independently to change an exit angle of light reflected thereby to be switched between an ON state, in which said light reflected by said each microscopic mirror travels in a first direction, and an OFF state, in which said light reflected by said each microscopic mirror travels in a second direction different from said first direction; and
a projection lens on which said light traveling in said first direction is incident to be magnified and projected to a screen through said projection lens.

2. The graphic display device according to claim 1, wherein a cut-out portion of said second mirror inside an effective aperture thereof is formed to prevent light reflected by said array of microscopic mirrors from being partly intercepted by said second mirror before reaching said projection lens.

3. The graphic display device according to claim 1, wherein a cut-out portion of said first mirror inside an effective aperture thereof is formed to prevent light reflected by said first mirror from being incident directly on said projection lens.

4. The graphic display device according to claim 1, wherein a principal ray of reflected light from said array of microscopic mirrors is inclined to an optical axis of said projection lens in a direction away from said first mirror and said second mirror.

5. The graphic display device according to claim 1, wherein said each microscopic mirror is rectangular in shape and swings about a rotational axis extending in a widthwise direction of said substrate to be switched between said ON state and said OFF state.

6. The graphic display device according to claim 1, wherein said each microscopic mirror is rectangular in shape and swings about a rotational axis extending in a lengthwise direction of said substrate to be switched between said ON state and said OFF state.

7. The graphic display device according to claim 1, wherein said each microscopic mirror is square in shape and swings about a rotational axis extending in a direction of a diagonal line of a square reflecting surface of said each microscopic mirror.

8. The graphic display device according to claim 1, wherein a reflecting surface of said first mirror is flat, and a reflecting surface of said second mirror is spherical.

9. The graphic display device according to claim 1, wherein a reflecting surface of said first mirror is cylindrical, and a reflecting surface of said second mirror is spherical.

10. The graphic display device according to claim 1, wherein a reflecting surface of said first mirror is flat, and a reflecting surface of said second mirror is aspherical.

11. The graphic display device according to claim 1, wherein both a reflecting surface of said first mirror and a reflecting surface of said second mirror are spherical.

12. The graphic display device according to claim 1, wherein said color separation filter comprises a rotary color separation filter having a red filter, a green filter and a blue filter which are arranged at equi-angular intervals about an axis of rotation of said a rotary color separation filter.

13. A graphic display device comprising:
a light source;
a light tunnel;
a condenser optical element for condensing light emitted from said light source upon an incident end of said light tunnel;
a rotary color separation filter, provided between said condenser optical element and said incident end of said light tunnel, for producing three primary colors periodically;
a relay lens system through which light emerging from an exit end of said light tunnel passes;
a first mirror on which said light which passes through said relay lens system is incident;
a second mirror on which said light incident on said first mirror to be reflected thereby is incident;
an optical reflecting device including an array of microscopic mirrors arranged in the form of a two-dimensional matrix on a substrate, said light incident on said second mirror and reflected thereby being incident on said array of microscopic mirrors, wherein each of said microscopic mirrors tilts independently to change an exit angle of light reflected thereby to be switched between an ON state, in which said light reflected by said each microscopic mirror travels in a first direction, and an OFF state, in which said light reflected by said each microscopic mirror travels in a second direction different from said first direction; and
a projection lens on which said light traveling in said first direction is incident to be magnified and projected to a screen through said projection lens.
